(19) United States
(12) Patent Application Publication
(10) Pub. No.: US 2020/0207607 A1
(43) Pub. Date: Jul. 2, 2020

(54) ANATOMICAL PAD AND SADDLE ASSEMBLY

(71) Applicant: AMAHORSE TRADING S.r.l., San Giustino (Perugia) (IT)

(72) Inventor: Mauro BENETTI, Lonato del Garda (Brescia) (IT)

(21) Appl. No.: 16/642,399

(22) PCT Filed: Aug. 31, 2018
(86) PCT No.: PCT/IB2018/056661

§ 371 Date: Feb. 27, 2020

(30) Foreign Application Priority Data
Sep. 1, 2017 (IT) 102017000098272

(51) Int. Cl. B68C 1/12

(52) U.S. Cl. CPC B68C 1/126

(57) ABSTRACT

An anatomical pad of a saddle for horse riding, comprising a flexible body defining a first body surface configured to abut against a seat surface of the saddle, and a second body surface intended to support a user of the saddle and separated from the first surface by the thickness of the pad is provided. The anatomical pad comprises a portion of yielding material to at least partially cushion the stresses between the saddle and the user, the portion of yielding material defining one or more pressure relief sites wherein the thickness of the yielding material is at least partially decreased to reduce, in a localized way, contact pressure between the seat surface and an anatomical area of the user.

The present invention concerns an anatomical pad of a saddle, specifically configured to be interposed between a saddle seat surface and a rider. This anatomical pad is configured for the riding of animals by humans, preferably for horse riding.

In order to improve the riding comfort of a rider, it is known to interpose mats between the back of a horse and a riding saddle. In addition to partially cushioning the stresses between the horse and the rider, the traditional mats are configured to prevent accidental slippage of the saddle relative to the back.

One of the main drawbacks of such solution is that, from the rider's point of view, the stress absorption function is partially lost due to the necessary stiffness of the saddle.

Therefore, riders suffering from specific conditions, such as pain in the pubis or in the coccyx, are unlikely to find relief through the use of the currently available mats.

The present invention is relevant to the preceding context, aiming to provide an anatomical pad for a saddle configured to be placed in a position closer to the rider, and shaped so as to reduce at least in part the contact stress of the saddle against the rider's areas of greater sensitivity.

Such objective is achieved by means of an anatomical pad according to claim 1, and by an assembly according to claim 10. The claims dependent thereon illustrate advantageous or preferred embodiments.

The object of the present invention will now be described in detail, with the aid of the accompanying figures, wherein:

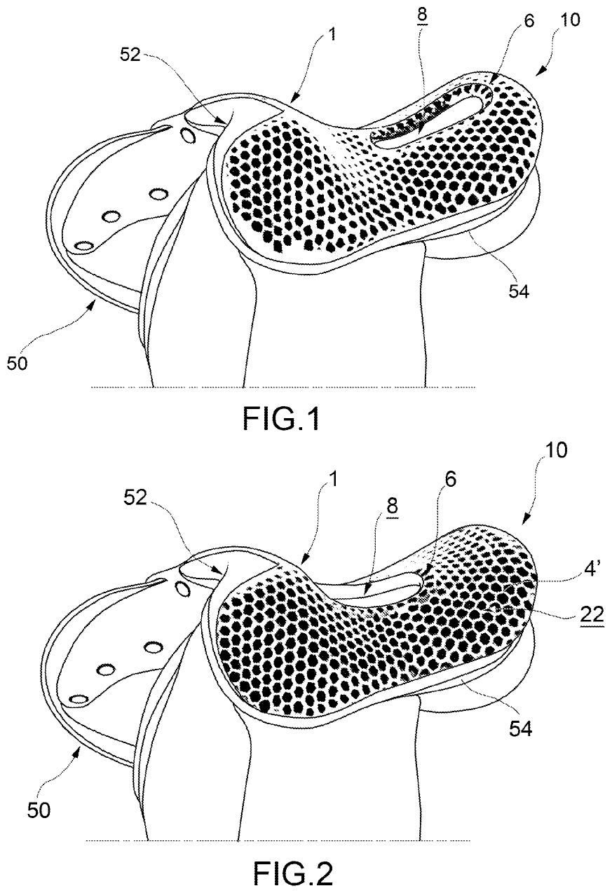

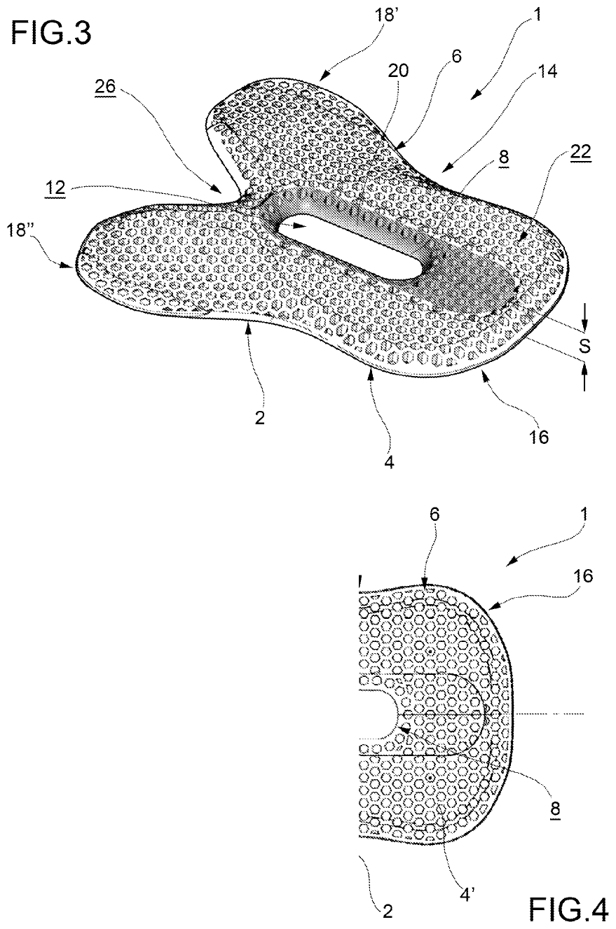

FIGS. 1, 2 show two perspective views of two assemblies, object of the present invention, according to two distinct possible variants;

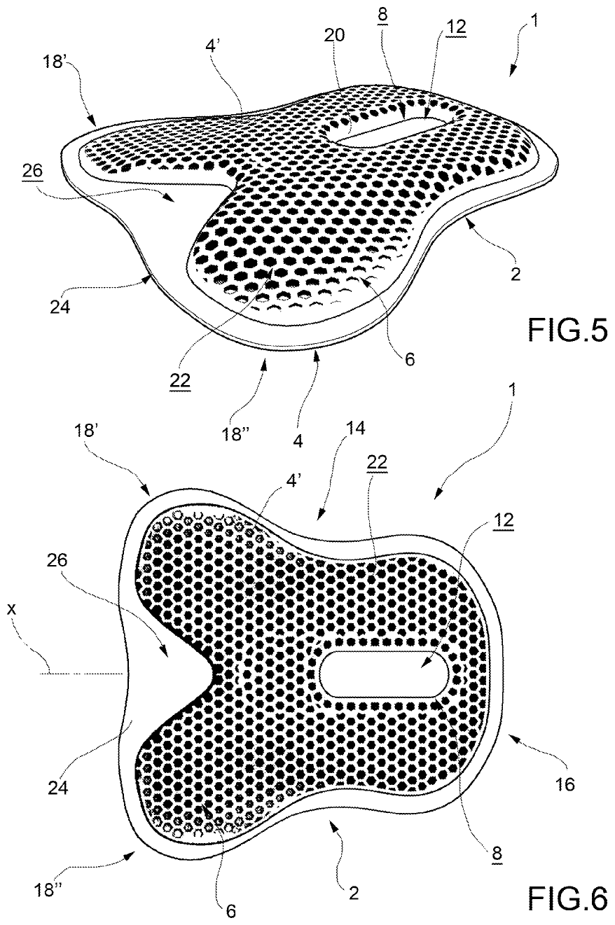

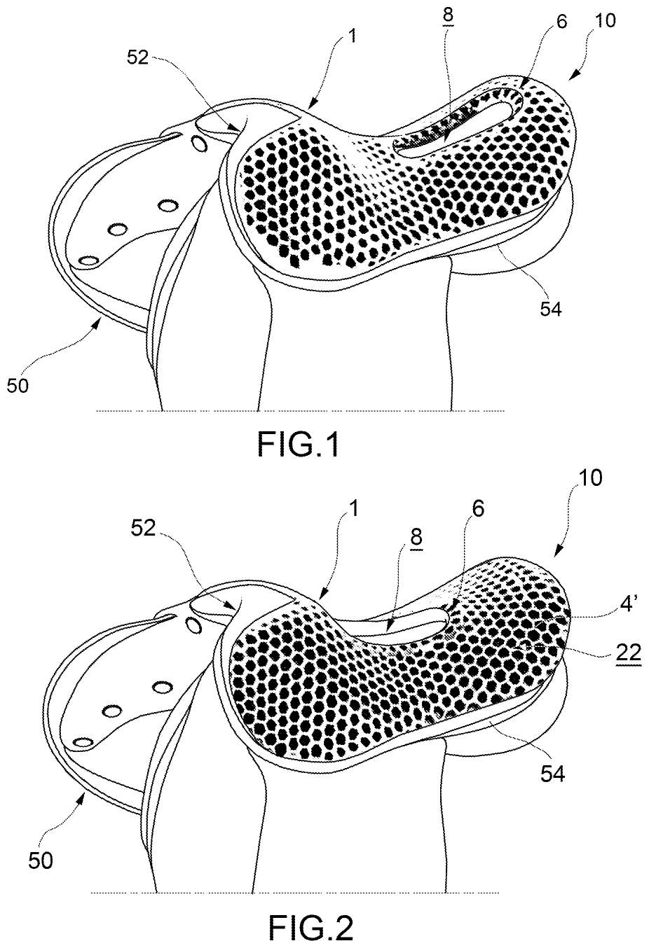

FIGS. 3, 4 show respectively a perspective view from above and a plan view of a similar cushioning element—in terms of the positioning of the pressure relief site—to the one shown in the variant of FIG. 2;

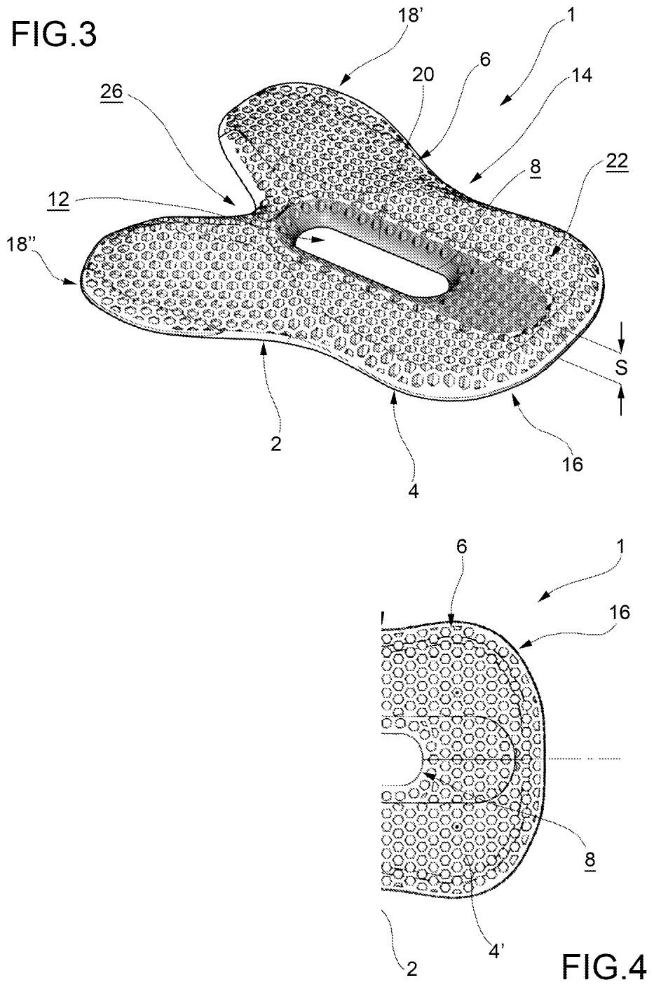

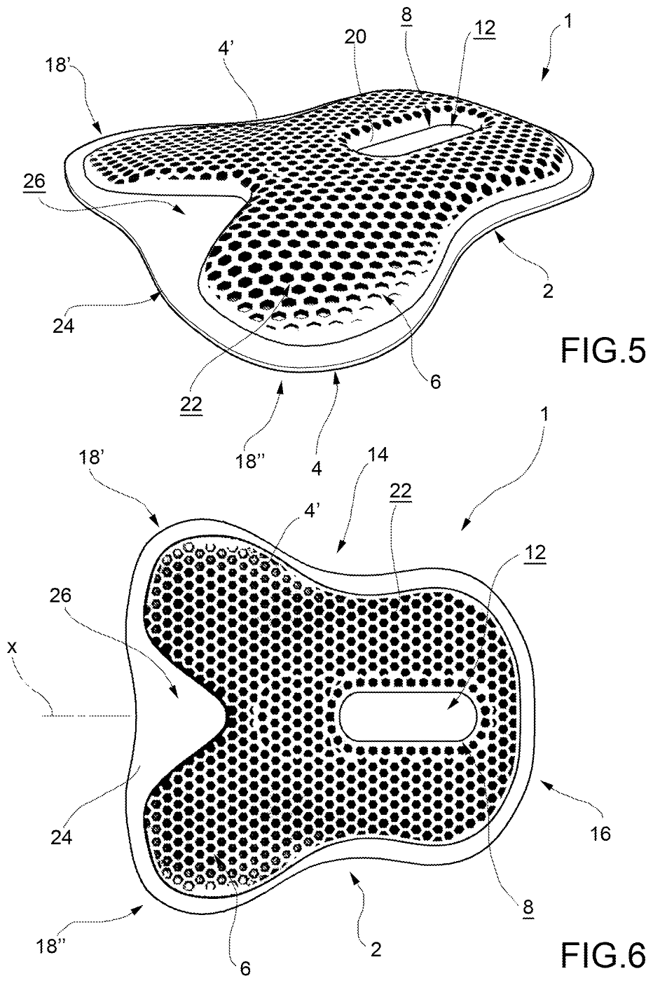

FIGS. 5 and 6 illustrate respectively a perspective view from above and a plan view of the cushioning element shown in the variant of FIG. 1.

With reference to the aforesaid figures, the reference number 1 has been used to indicate, as a whole, an anatomical pad of a riding saddle 50.

Such anatomical pad comprises a flexible body 2 defining a first body surface 4 configured to abut against a seat surface 54 of the aforesaid saddle 50, and a second body surface 4′ intended to support a user or rider of the saddle 50, such second surface being separated from the first surface 4 by the thickness S of the pad 1.

The anatomical pad 1 comprises at least one portion 6 made of yielding material to at least partially cushion the stresses between such saddle 50 and the user.

According to one embodiment, the portion 6 made of yielding material comprises at least one padding.

According to one embodiment, the yielding material of the portion 6 is a polymer, for example, viscoelastic, in gel or foam.

The aforesaid portion 6 defines one or more pressure relief sites 8 in which the thickness of the yielding material is at least partially decreased in order to reduce—in a localized manner—the contact pressure between the seat surface 54 and an anatomical area of the user.

It follows that, without prejudice to the function of cushioning/damping stresses, the present pad has been designed to decrease the compression of certain anatomical areas of the rider, such as areas of greater sensitivity.

According to one embodiment, the anatomical area is a bony area such as the coccyx and/or the pubis of the user.

It is important to point out that, although the embodiments shown in the accompanying figures always show the portion 6 made of yielding material facing the user, the present pad could also be used in an inverted way with respect to the illustrations, in particular with the aforesaid portion 6 made of yielding material facing the seat surface 54.

According to one embodiment, the anatomical pad 1 comprises a single portion 6 made of yielding material.

According to one embodiment, the portion 6 made of yielding material or the plurality thereof is extended.

Please note that, in the present description, the term “extended” means a coverage at least predominant (i.e. more than 50%) or essentially complete of at least one body surface 4, 4′.

According to one embodiment, the yielding material is absent in the pressure relief site 8.

In other words, in such variant, the anatomical pad 1 is perforated through and through (e.g. see variant in FIG. 3) or is perforated completely through only the portion 6 (but not through the body base 24 discussed hereinafter; for example, see FIGS. 5-6).

According to one embodiment, a material that is more yielding than the yielding material of portion 6 is placed in the pressure relief site 8.

According to one embodiment, the portion 6 made of yielding material extends annularly so as to circumscribe a pressure relief site 8 or a pressure relief cavity 12.

According to one embodiment, the pressure relief site 8 extends in an elongated manner—for example substantially ellipsoidal or ovoidal—along a predominant direction of extension X of the flexible body 2 or of the portion 6 made of yielding material.

In the variants shown, the predominant direction of extension X extends along the spine of an animal on which the saddle 50 is placed.

According to one embodiment, the pressure relief site 8 is arranged at a substantially central portion 14, or a rear portion 16, of the flexible body 2 or of the portion 6 made of yielding material.

According to one embodiment, the pressure relief site 8 is defined by one or more edges 20 that extend in an incident direction, non-orthogonal to one of the body surfaces 4, 4′.

In other words, the site 8 according to this variant has one or more edges 20 flared towards the outside.

According to one embodiment, the edges 20 are made of yielding material.

According to one embodiment, the pressure relief site 8 is defined on one or more sides by the yielding material, which gradually tapers towards the inside of such site 8.

According to one embodiment, the thickness S of the pad 1 is penetrated at least in part by a plurality of ventilation perforations 22 or ventilation micro-perforations.

According to one embodiment, the ventilation perforations 22 are wide (i.e. with a cross-section of at least 0.5 mm2) at the portion 6 made of yielding material.

According to one embodiment, the flexible body 2 comprises a body base 24, and the yielding material of the portion 6 is a polymer (micro-)injected onto or into the body base 24.

It follows that, in this variant, the yielding material and the base have a real anchorage that makes them substantially monolithic.

According to one embodiment, the flexible body 2 comprises a body base 24, and the yielding material of the portion 6 is joined (e.g. glued or sewn) to the body base 24.

According to one embodiment, the body base 24 comprises a fabric, a cloth, a layer of polymer and/or of leather.

According to one embodiment, the body base 24 defines the ventilation micro-perforations.

According to one embodiment, the flexible body 2 consists of the portion 6 made of yielding material, so that the first 4 and the second 4′ body surfaces are defined by such portion 6 made of yielding material.

According to one embodiment, the flexible body 2 or the portion 6 made of yielding material extends along the predominant direction of extension X between a rear portion 16 and a pair of front branches 18′, 18″.

According to one embodiment, the front branches 18′, 18″ define a receiving space 26 to be at least geometrically coupled with a knob 52 or a horn of the riding saddle 50.

The present invention also concerns a saddle assembly 10 comprising a saddle for horse riding 50 and an anatomical pad 1 according to any of the embodiments discussed above, wherein the first body surface 4 of the flexible body 2 is placed to abut against a seat surface 54 of such saddle.

According to one embodiment, the anatomical pad 1 and the saddle 50 are connected in a releasable way.

According to one embodiment, the anatomical pad 1 is shaped in such a way that it may be paired with any saddle of the prior art.

Innovatively, the pad object of the present invention is able to successfully overcome the drawbacks of the prior art.

More precisely, such pad has been designed to reduce the compression of specific anatomical structures of the user/rider.

Advantageously, the pad object of the present invention is suitable to be manufactured in an extremely economical way.

Advantageously, the pad object of the present invention has appropriate anti-slip features, which drastically reduce the risk of accidents.

Advantageously, the pad object of the present invention has been designed to be breathable for the user.

Advantageously, the portion made of yielding material is anchored to the base thereof, so that accidental detachment is essentially avoided.

Advantageously, the use of a polymeric or viscoelastic material gives the present pad suitable or remarkable surface adhesion features.

Advantageously, the pad object of the present invention has appropriate cushioning properties, making riding more comfortable.

To the embodiments of the aforesaid pad and assembly, one skilled in the art, in order to meet specific needs, may make variants or substitutions of elements with other functionally equivalent ones.

These variants are also contained within the scope of protection as defined by the following claims.

Furthermore, each variant described as belonging to a possible embodiment may be achieved independently of the other described variants.

1. An anatomical pad of a riding saddle, comprising a flexible body defining a first body surface configured to abut against a seat surface of said riding saddle, and a second body surface intended to support a user of said riding saddle and separated from said first body surface by a thickness of said anatomical pad;
wherein the anatomical pad further comprises at least one portion of yielding material to at least partially cushion stresses between said riding saddle and said user, said at least one portion of yielding material defining a pressure relief site, wherein thickness of the yielding material is at least partially decreased to reduce, in a localized way, contact pressure between the seat surface and an anatomical area of the user, including coccyx and/or the pubis.

2. The anatomical pad of claim 1, wherein the yielding material is absent in the pressure relief site, and wherein said at least one portion of yielding material extends annularly to circumscribe a pressure relief cavity.

3. The anatomical pad of claim 1, wherein the pressure relief site extends ellipsoidally or ovoidally in a predominant direction of extension of the flexible body or of the at least one portion of yielding material, and wherein said pressure relief site is arranged on a central portion or a rear portion of the flexible body or of the at least one portion of yielding material.

4. The anatomical pad of claim 1, wherein the pressure relief site is defined by one or more edges of yielding material, which extend in an incident direction, non-orthogonal to one of said first body surface and said second body surface.

5. The anatomical pad of claim 1, wherein the pressure relief site is defined on one or more sides by the yielding material, which becomes progressively thinner towards the inside of said pressure relief site.

6. The anatomical pad of claim 1, wherein the thickness of the anatomical pad is penetrated at least in part by a plurality of ventilation perforations or ventilation micro-perforations, said ventilation perforations being wide, having a cross-section of at least 0.5 mm² at the at least one portion of yielding material.

7. The anatomical pad of claim 1, wherein the flexible body comprises a body base comprising a fabric, and wherein the yielding material of said at least one portion of yielding material is a viscoelastic polymer in gel or foam (micro-)injected onto or into the body base.

8. The anatomical pad of claim 1, wherein the flexible body consists of at least one portion of yielding material, so that the first body surface and the second body surface are defined by said at least one portion of yielding material, said at least one portion of yielding material being at least partially made of a viscoelastic polymeric material in gel or foam.

9. The anatomical pad of claim 1, wherein the flexible body or the at least one portion of yielding material extends along a predominant direction of extension between a rear portion and a pair of front branches defining a receiving space to be at least geometrically coupled with a knob or with a horn of said riding saddle.

10. A saddle assembly comprising:
a riding saddle;
and the anatomical pad of claim 1.
